(19) United States
(12) Patent Application Publication
(10) Pub. No.: US 2006/0046034 A1
(43) Pub. Date: Mar. 2, 2006

(54) Solid surface products

(75) Inventor: Dennis A. Schober, Newcastle, WA (US)

Correspondence Address: BLACK LOWE & GRAHAM, PLLC, 701 FIFTH AVENUE, SUITE 4800, SEATTLE, WA, 98104, US

(73) Assignee: Schober, Inc.

(21) Appl. No.: 11/262,467

(22) Filed: Oct. 27, 2005

Related U.S. Application Data
(63) Continuation-in-part of application No. 10/762,206, filed on Jan. 21, 2004.
(63) Continuation-in-part of application No. 10/794,172, filed on Mar. 5, 2004.
Application No. 10/762,206 is a division of application No. 10/106,833, filed on Mar. 25, 2002, now Pat. No. 6,743,327.
Application No. 10/794,172 is a continuation-in-part of application No. 10/106,833, filed on Mar. 25, 2002, now Pat. No. 6,743,327.
(60) Provisional application No. 60/307,898, filed on Jul. 25, 2001.

(51) Int. Cl. B41M 5/00

(52) U.S. Cl. 428/195.1

(57) ABSTRACT

A bullet resistant, non-porous unitary solid surface structure. The structure includes a first non-porous unitary material, a decorative material, and a second non-porous unitary material. The second non-porous unitary material is fused to the first non-porous unitary material in opposed relation relative to the decorative material. The fused materials produce a bullet resistant structure. The first and second non-porous unitary materials include at least one of acrylic, cross-linked acrylic, polymethyl methacrylate, polycarbonate, polyvinyl chloride, polyethylene, polypropylene, polyester, nylon, polyurethane, polystyrene, fluoropolymers, acrylonitrile-butadiene-styrene, polylactic acid, and cellulosics.

### CROSS-REFERENCE TO RELATED APPLICATIONS

This is a continuation-in-part of U.S. patent application Ser. No. 10/762,206 filed on Jan. 21, 2004, and a continuation-in-part of U.S. patent application Ser. No. 10/794,172 filed on Mar. 5, 2004. 10/762,206 is a divisional application of and 10/794,172 is a continuation-in-part application of U.S. patent application Ser. No. 10/106,833, filed Mar. 25, 2002, which claims priority from U.S. Provisional Application Ser. No. 60/307,898 filed Jul. 25, 2001. Each of the Utility Patent applications and the Provisional Patent application is incorporated by the references above.

### BACKGROUND OF THE INVENTION

Rapid heating and cooling of thermoplastics causes cloudiness and voids in currently produced laminated matrices. Such clouding compromises the translucent and aesthetic value of the product. Lamination processes as currently configured include either of a single pressing or rolling pressing thermoplastic materials into contact with each other. As the material cools after fusion, differentials in the thermal expansion of materials introduces stresses and strains, while thermoplastic materials outgassing upon heating provide gas to further urge apart thermoplastic strata on a microscopic level flowing into voids created by the stresses and strains.

Maintaining clarity in a translucent product is very difficult. The problem is compounded when configured matrices are bent. The presence of voids or gas in the matrix causes internal absorption of light tending to make the product look dull. On the other hand, clear material will reflect and diffuse the light to add to the decorative effect of formed thermoplastic.

Suspending décor materials in thermoplastic introduces additional sources of gas in the matrix and simultaneously introduces an additional interface for stressing and straining the matrix. Additionally, introducing the central material alters the geometry of the matrix to force an increased differential between a first and second strata material separated by the thickness of the décor material.

What is needed in the art is a method and system for forming unitary matrices of strata of thermoplastics to minimize included gasses and to relieve internal stresses and strains to yield finished products of exceptional depth, clarity and beauty.

### BRIEF SUMMARY OF THE INVENTION

The present invention includes a bullet resistant, non-porous unitary solid surface structure. The structure includes a first non-porous unitary material, a decorative material, and a second non-porous unitary material. The second non-porous unitary material is fused to the first non-porous unitary material in opposed relation relative to the decorative material. The fused materials produce a structure that is highly impact resistant or bullet resistant. The first and second non-porous unitary materials include at least one of acrylic, cross-linked acrylic, polymethyl methacrylate, polycarbonate, polyvinyl chloride, polyethylene, polypropylene, polyester, nylon, polyurethane, polystyrene, fluoropolymers, acrylonitrile-butadiene-styrene, polylactic acid, and cellulosics.

### BRIEF DESCRIPTION OF THE DRAWINGS

The preferred and alternative embodiments of the present invention are described in detail below with reference to the following drawings.

FIG. 1a is a composite cross-section showing the individual strata of the lay up matrix component stack;

FIG. 1b is a composite cross-section showing the fused lay up matrix;

FIG. 2a is a composite cross-section showing the individual strata of the lay up matrix component stack including an LED network;

FIG. 2b is a composite cross-section showing the fused lay up matrix including an LED network;

FIG. 3 is a flowchart for the inventive process; and

FIG. 4 is a composite cross-section showing a fused lay up matrix having bullet resistant properties.

### DETAILED DESCRIPTION OF THE INVENTION

Thermoplastics share a quality of being fusible at suitable temperatures while maintained in contact under suitable compressive forces. Sheets of thermoplastic are fused together along a face on opposing faces of a decorative material; the resulting laminate is configured to include decorative materials such as fabric, paper, plastic film, plastic sheet, metallic wire, rod, mesh, sheet, foil or bar, grass, reeds, shells, glass, stone, electroluminescent particles, photo luminescent particles, fiber optic material and LED embedment, wood veneer, natural materials such as tree or plant bark, leaves, petals, twigs within, or on the surface of, sheets of plastic or glass.

Advantageously, each of the various thermoplastic sheets enter a plastic phase at the fusion temperature according to the selected material and at that plastic phase, the thermoplastic sheets may be suitably formed around molds. Forming the sheets of thermoplastic to create laminates allows the manufacture of useful surfaces such as basins for bathtubs, column wraps, sinks, and lavatories; suitably curved sheets for countertops with formed features such as basins for sinks and soaptrays. Where planar surfaces are desired such as decorative fascia plates, appliance cases and fronts, drawing boards, countertops, flooring, wall and ceiling panels, door inserts, window panes, canopies, ceilings, floors, the molds used are planar.

For purposes of this application, the term lay up material shall mean generally planar sheets of thermoplastic composition being heatable to a fusion point, the fusion point being a temperature causing the lay up material to enter a plastic phase such that contact with a second lay up material at its fusion point will cause the two layup materials to fuse to form a lay up matrix.

A generally planar sheet for the purposes of this patent application shall mean a quantum of lay up material configured to have a first surface and a second surface spaced apart at a generally uniform distance from the first surface to form a sheet, the sheet having a sheet edge. The term generally planar sheet includes true planar sheets but also includes sheets having a curvature whether such sheets are concave, convex or piecewise concave or convex. An engaging pair of generally planar sheets are a first generally planar sheet configured to engage the surface of a second generally planar sheet such that the convexities of a first sheet engaging surface are located and configured to suitably mate with concavities of a second sheet engaging surface and likewise the concavities of the first sheet engaging surface are located and configured to suitably mate with the convexities of the second sheet engaging surface.

A generally planar sheet may have its sheet engaging surface textured to assist in the evacuation of outgases from the bonding process. In an embodiment of the invention such texturing is useful to enhance either of venting or drawing of outgases from a lay up matrix during application of heat and pressure. Texturing of the sheet engaging surface is not a departure from the definition of a generally planar sheet.

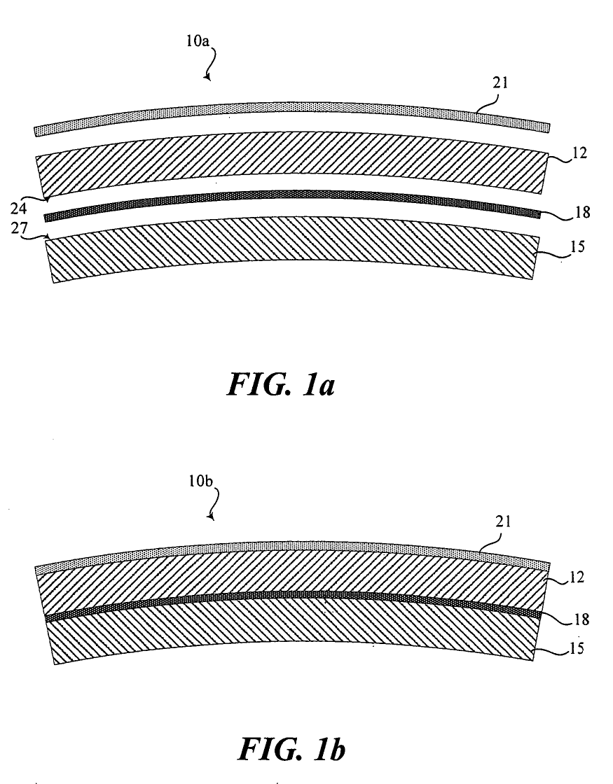

Referring to FIG. 1a, a first generally planar sheet 12 of lay up material has a first sheet engaging surface 24 and a second generally planar sheet 15 of lay up material has a second sheet engaging surface 27. Convexity of the first sheet engaging surface 24 is located and configured to suitably mate with the concavity of the second sheet engaging surface 27. The first generally planar sheet 12 and the second generally planar sheet 15 form an engaging pair of generally planar sheets.

The first generally planar sheet 12 and the second generally planar sheet 15 include a lay up material. The type of lay up material and the thickness of the first generally planar sheet 12 and the second generally planar sheet 15 ranges over a wide spectrum, though temperatures used for fusion of each are based upon a lay up material fusion point defined for each distinct lay-up material. Where the first generally planar sheet 12 and the lay up material the second generally planar sheet 15 include materials with diverse plastic phases, such as a first generally planar sheet 12, including a first thermoplastic lay up material and second generally planar sheet 15, including a second thermoplastic lay up material, a polyolefin, polyester, polyurethane, nylon, vinyl or PVB heat-activated film adhesives interposed between the first sheet engaging surface 24 and the second sheet engaging surface 27, such as the film adhesives available through such chemical producers as Bemis™ located in Shirly, Mass. or DuPont™ located in Buffalo, N.Y., will suitably adhere rather than to fuse the first generally planar sheet 12 to the second generally planar sheet 15 to form the lay up matrix 10a.

Suitable of the thermoplastic materials for use as either of the first generally planar sheet 12 and the second generally planar sheet 15 are resins, such as acrylic resins, for example Polymethyl Methacrylate (PHMA), Polycarbonate, Polyvinyl Chloride, Polyethylene in either of high density polyethylene and low density polyethylene, Polypropylene, Polyester, Nylon and Polyurethane, Polystyrene, Fluoropolymers, Acrylonitrile-Butadiene-Styrene (ABS). Materials can be blended to create combination plastics, such as CPVC, ABS/Polycarbonate, ABS/PVC, Polycarbonate/Acrylic, or PVC/Acrylic. Biodegradable thermoplastics such as polylactic acid (PLA) and cellulosics such as ethyl cellulose, cellulose acetate, cellulose acetate butyrate, cellulose acetate propioniate, and cellulose nitrate serve suitably as the first generally planar sheet 12 and the second generally planar sheet 15 allowing fusion. By way of nonlimiting example, the first generally planar sheet 12 and the second generally planar sheet 15 have typical thicknesses of between 0.004″ (0.100 mm) and 1″ (25.4 mm).

Addition of one of a number of known antimicrobial polymers prevents later growth of potentially harmful bacteria, molds, and fungi in any of an array of industrial, institutional, and consumer products. One such antimicrobial polymers for addition to the thermoplastic material is the Microban™ polymer manufactured by the Microban Products Company™. Antimicrobial additives go into the products and materials they protect during the manufacturing process, yielding an inherently effective defense against the growth of microbes and a protection that won't wash off or wear away. Addition of an antimicrobial polymer would make the resulting matrix 10b especially useful for such products as children's chairs, changing tables, and countertops or any area where accumulation of microbes is a concern.

Using such thermoplastic materials, allows a wide variety of combinations of heat and pressure to achieve a fusion of the first generally planar sheet 12 and the second generally planar sheet 15 as fusion ranges at temperatures of between 185 and 600 degrees and between pressures of between 50 to 250 PSI. At such temperature and pressure combinations, fusion will suitably occur at between 3 seconds and 45 minutes of dwell time.

The decorative material 18 may optionally include clear float glass, annealed or tempered glass. Surfaces of the glass may be suitably textured, tinted, frosted, etched, stained, colored, or sandblasted. Typically, thicknesses ranging from 0.090″ (2.5 mm) to 1″ (25.4 mm) are used to allow for suitable or uniform heating across the first generally planar sheet 12 and the second generally planar sheet 15. The glass introduces a significant variance in a specific heat of either of the first generally planar sheet 12 and the second generally planar sheet 15. A thicker or a thinner first generally planar sheet 12 and the second generally planar sheet 15 will tend to shift the specific heat allowing the suitable fusion of the first generally planar sheet 12 and the second generally planar sheet 15 with suitable modification of heating and cooling times.

Whether the lay up matrix component stack 10a is bonded by fusion or adhesion, interposed between the first sheet engaging surface 24 and the second sheet engaging surface 27 a decorative material 18 engages each of the first sheet engaging surface 24 and the second sheet engaging surface 27. The decorative material 18 is either adhesively bonded to or fused with the first sheet engaging surface 24 of the first generally planar sheet 12 and the second sheet engaging surface 27 of the second generally planar sheet 15.

The decorative material 18 may include any material suitable for encasement. Where fusion is used to join the first generally planar sheet 12 to the second generally planar sheet 15, the decorative material 18 is chosen to withstand temperatures necessary to reach the fusion point of each of the first generally planar sheet 12 and the second generally planar sheet 15. Bonding by adhesion allows greater latitude in selections, as the activation temperature of the adhesives may be less than that of fusion. In discussing the decorative materials 18, none of the typical thicknesses listed are limiting but, rather, suggest the thicknesses of decorative materials 18 in which the materials are typically available for embedment.

Suitable decorative materials 18 may include textile or fibrous materials. Textile materials include synthetic, semi-synthetic, and naturally occurring and polymeric. Polymeric materials include fibers such as rayon, polyester, nylon, synthetic polyamides including nylon 66 and nylon 6, acrylic, modacrylic and cellulose acetate, cotton, wool, silk and fiberglass. The textile materials may be woven, knitted, spun-bonded, or prepared by other well-known processes in the textile trade. The textile materials may be printed, coated, dyed, sublimated or decorated by other techniques known within the textile trade. While other thicknesses for textile materials will work, textile materials of thicknesses ranging from: 0.00045″ (0.0114 mm) to 0.25″ (6.35 mm) have proven readily incorporable into the matrix 10a.

The decorative material 18 may include natural fibers in an unwoven state. Such natural fibers include wood veneer, paper and plant fibers and parts. Fibers of cellulose, cotton, linen, pulp, rag, high alpha, dried plant materials and fibers including leaves, petals, bark and twigs from reed, bamboo, papyrus, banana, mulberry, Kozo, Unryu, wicker, tobacco, sulphite pulp, hemp, Gampi, Goyu, Hosho, Tableau, wood veneers (with paper, saturated paper or foil backings and fabricated veneers) may be incorporated into the matrix 10a. The natural fibers may include processed materials that are colored, printed, coated, saturated, metalized, sublimated, dyed, textured, painted, embossed, woven, foil stamped, or prepared by other well known processes in the paper and wood trades. Where natural fibers are used, successful incorporation has included natural fiber materials of typical thicknesses ranging from 0.00045″ (0.0114 mm) to 0.25″ (6.35 mm).

Decorative materials 18 may include metals or metal inclusions. Metals are generally selected to have melting points in excess of the selected fusion points of the first generally planar sheet 12 and the second generally planar sheet 15. Such metals include copper, steel, iron, brass, nickel, and aluminum. Magnets such as those of ferrite or neodymium iron boron are readily inserted as metal inclusions. Inclusions may be formed of a variety of shapes including rod, mesh, sheet, perforated sheet, foil, strips, shavings, woven, cable, as well as castings, stampings, and forgings. Metal inclusions may be decorated such as etched, anodized, sanded, brushed, stained, painted, printed, chemically treated, galvanized, corroded, aged, polished, chromed, plated. For metal inclusions, typical thickness: 0.00045″ (0.0114 mm) to 1″ (25.4 mm) are the easiest for inclusion but other sizes may be accommodated with suitable adjustment of the fusion time.

The decorative materials 18 may also include ornamental items. Because of the plasticity of the first generally planar sheet 12 and the second generally planar sheet 15 at the fusion point, such decorative inclusions such as agates, marine shells, coral, glass beads, gems, and costume jewelry will readily serve as decorative materials 18. Additionally, photoluminescent objects will retain the photoluminescence after inclusion as a decorative material 18 as a positive effect in displays, signage, ceilings, light fixtures, countertops, sink bowls, ceilings, floors, wall covering, furniture, and consumer products. As such, the lay up matrix 10b may be suitably fashioned as a presentation novelty or plaque.

Apart from the fibrous and metal materials, the decorative materials 18 may also include either a plastic sheet or a film of thermoplastic composition such as any of the several acrylics such as polymethyl methacrylate PHMA, Polycarbonate, polyvinyl chloride, PETG, copolyester, polyethylene, polypropylene, polyester, PVDF such as Kynar™, PVF such as Tedlar™, and polyurethane. Nor is it necessary that the decorative material 18 be a sheet. Plastic materials suitable for inclusion can be in any of cast, extruded, coated, calendared, or formed configurations. The plastic materials can include variations in qualities of the plastic such as different colors, finishes varying in texture, qualities of light transmission such as frosting, translucence, and opacity. Decorative qualities of the resulting lay up matrix 10a may optionally be enhanced by the eye-catching features included in the decorative materials 18. Such features may be distinctively colored, printed, metalized, sublimated, dyed, textured, painted, embossed, or foil stamped.

Qualities of the resulting lay up matrix 10b may be enhanced by selection of plastics for inclusion; qualities such as fire retardance are enhanced by inclusion of a fire retardant or resistant decorative material 18. Likewise, selecting a foamed core, honeycomb core, or perforated core decreases the density of the resulting lay up matrix 10b.

Optionally, films 21 may be affixed to the lay up matrix including such specialty films configured to enhance abrasion, chemical, or UV (ultraviolet) resistance of thermoplastic laminates in the first generally planar sheet 12 or the second generally planar sheet 15. The specialty films include polyester, Polyvinyl floride known as PVF, Ethylene/trifluoro ethylene known as ETFE, fluorinated ethylene propylene known as FEP, polyvinylidene floride known as PVDF, chlorotrifluoro ethylene known as CTFE, or acrylic resin film such as polymethyl methacrylate, as well as various polymer extruded products.

Typically, such films have a higher melt point than the fusion point of thermoplastic used for the first generally planar sheet 12 and the second generally planar sheet 15. Because the fusion temperature of such films is high enough to melt the thermoplastics allowing the thermoplastic to flow out of the pressure fixture, the fixation of the film 21 to either the first generally planar sheet 12 or the second generally planar sheet 15 requires interposing a heat activated adhesive coating to be applied to the film prior to bonding to most plastic substrates. Generally, the film's thickness ranges from 0.004″ (0.100 mm) to 0.020″ (0.500 mm).

Film adhesion has also proven to be a very good means to achieve abrasion resistance in the resulting lay up matrix 10b. Films that lend good abrasion resistance include those having heat, ultraviolet or electron beam cured material deposited on a film of polyvinyl chloride PETG copolyester, polyethylene terephthalate, polymethyl methacrylate or polycarbonate. In addition, the abrasion resistance coating can be achieved with a heat cured silicone, polyurethane or fluorinated polyurethane or an ultraviolet or electron beam cured material selected from modified acrylates containing polyurethane, fluorinated polyurethane, silicone, epoxy, polyester, polyether or caprolactone residues. A further purpose of using specialty films includes enhancing the native properties of the thermoplastic first generally planar sheet 12 or the thermoplastic second generally planar sheet 15 to give, by way of non-limiting example, abrasion resistance, ultraviolet protection, or enhanced optical properties such as reflectivity or opacity. So enhanced, the resulting matrix 10b may serve by way of non-limiting example, as a dry-write board, a projection screen, protective screens for blast or penetration resistance.

Transforming the lay up matrix component stack 10a to form the lay up matrix 10b requires application of both heat and pressure to achieve the fusion of the thermoplastics or heat activation of the adhesive films. While in most industrial settings, flat bed lamination is the principal means used for the simultaneous and controlled application of pressure and heat, such an application is generally most economical to produce a planar product of fixed dimensions. Fusion may be achieved by the inventive process for a nonplanar lay up matrix 10b by such means as vacuforming over a mold, flat bed lamination using a silicon blanket against a heated caul, or vacuum bagging with an autoclave. Additionally, to produce a planar lay up matrix, not only will a sheet press serve, but so too will a roll laminator or a vacuum forming machine. In each process, however, control of heat and application of pressure are means of achieving the fusion of generally planar sheets 12, 15 to a decorative material 18.

In some instances, it is desirable that the decorative material 18 be more than merely inert matter but rather be active components such as an array of light emitting diodes (LEDs) or electroluminescent materials, photoluminescent materials, fiber optic materials alone or in motorized displays, fluid vessels or transport channels including reservoirs or piping networks, as non-limiting examples. Moving or glimmering displays set into the lay up matrix 10b can provide an engaging and pleasing visual affect.

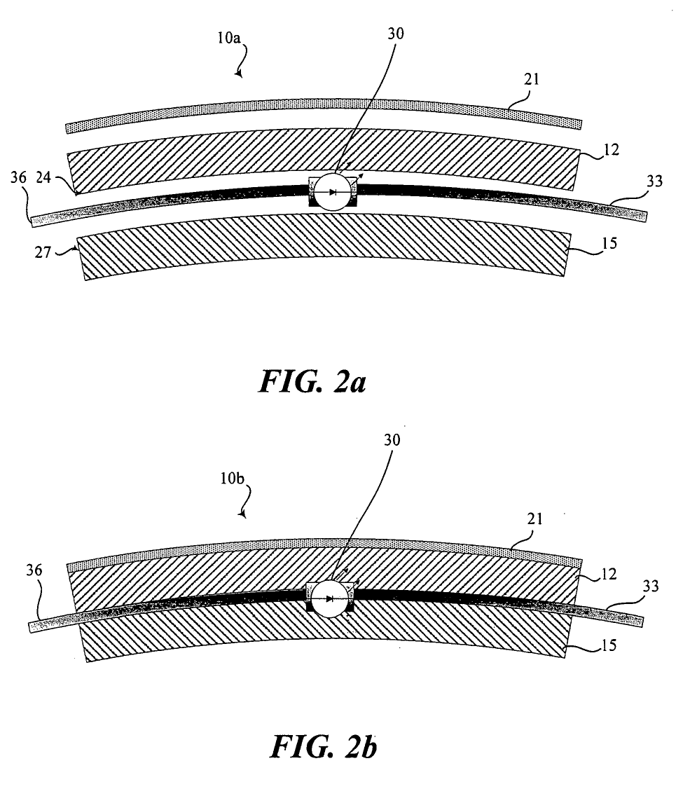

Referring to FIG. 2a, a lay up matrix component stack 20a, like the stack 10a, includes the first generally planar sheet 12 of lay up material having the first sheet engaging surface 24 and the second generally planar sheet 15 of lay up material having the second sheet engaging surface 27. Convexity of the first sheet engaging surface 24 is located and configured to suitably mate with the concavity of the second sheet engaging surface 27. The first generally planar sheet 12 and the second generally planar sheet 15 form an engaging pair of generally planar sheets.

Referring to FIGS. 2a and 2b, the lay up matrix component stack 20a is fused or bonded to form a lay up matrix 20b. Decorative material may suitably include electrical devices such as electrical lights sources, including by way of non-limiting example, LEDs, electrical heating devices such as resistive wires, and electrical motors to move mechanisms such as clockworks or fluid pumps to animate decorative displays. Commonly, electrical devices require a source of electrical current. Advantageously, electrical leads 33, 36 may extend out of the resulting lay up matrix 20b to allow placement of the current source outside of the matrix 20b.

To exemplify inclusion of electrical devices including electrical leads 33, 36, a non-limiting example of a network of LEDs 30 is included in the lay up matrix 20b. The lay up matrix component stack 20a includes first generally planar sheet 12 of lay up material having the first sheet engaging surface 24, the network of LEDs 30 along with leads 33, 36 extending at least to the edge of the resulting lay up matrix 20b, and the second generally planar sheet 15 of lay up material having a second sheet engaging surface 27 in opposed relationship to the first generally planar sheet 12 relative to the decorative material 18. Optionally, the leads 33, 36 advantageously extend beyond an edge of either the first generally planar sheet 12 or the second generally planar sheet 15, thus to allow suitable energizing of the embedded network of LEDs 30. Optionally, a film 21 overlays the first generally planar sheet 12 opposed relation to the decorative material. Upon fusing or bonding, the lay up matrix component stack 20a becomes a lay up matrix 20b.

Whether the lay up matrix component stack 20a is bonded by fusion or adhesion, interposed between the first sheet engaging surface 24 and the second sheet engaging surface 27. Just as the decorative material 18 (FIG. 1) engages each of the first sheet engaging surface 24 and the second sheet engaging surface 27, so too the LEDs 30 and the electrical leads 33, 36 engage each of the first sheet engaging surface 24 and the second sheet engaging surface 27. The LEDs 30 and the electrical leads 33, 36 are either adhesively bonded to or fused with the first sheet engaging surface 24 of the first generally planar sheet 12 and the second sheet engaging surface 27 of the second generally planar sheet 15.

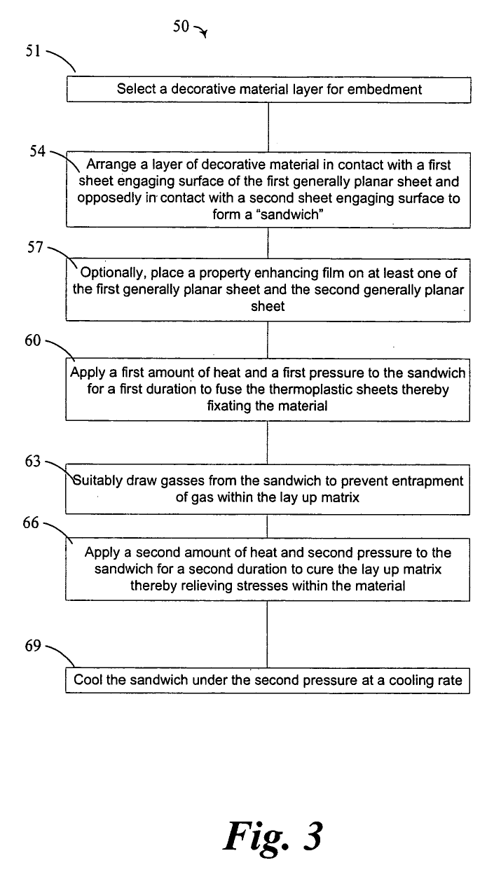

Referring to FIG. 3, a process 50 of fusing the lay up matrix component stacks 10a and 20a to form the lay up matrices 10b and 20b commences at a block 51 by positioning or “laying-up” thermoplastic or glass sheets and decorative materials in the correct sequence to create a “sandwich” and then applying heat and pressure to fuse the materials together creating a single sheet. At a block 51, a decorative material 18 is selected for embedment in the fused or bonded lay up matrices 10b and 20b. As indicated in FIG. 1a, the central strata of the lay up matrix component stacks 10a and 20a is the decorative material 18, the decorative material 18 being selected according to a desired finished appearance of the lay up matrices 10b and 20b.

At a block 54, the selected decorative material 18 is arranged with the first sheet engaging surface 24 of the first generally planar sheet 12 and the second sheet engaging surface 27 of the second generally planar sheet 15. Where, optionally, adhesives rather than fusion of materials are used as the bonding force between the decorative material 18 and each of the first sheet engaging surface 24 and the second sheet engaging surface 27, a heat activated adhesive film (not pictured) is interposed.

At a block 57, where desired, a film 21 is placed to enhance a quality desired in the fused or bonded lay up matrices 10b and 20b. As discussed above, films are selected according to desired attributes such as resistance to ultraviolet light degradation, scratch resistance, or coloration, among others. Generally, the films are not fused to the fused or bonded lay up matrices 10b and 20b so heat activated adhesive films (not shown) are interposed between either the first generally planar sheet 12 or the second generally planar sheet 15 and the desired film. Certainly, where desired, film may be adhered to both of the first generally planar sheet 12 and the second generally planar sheet 15, with suitable interposition of the adhesive sheets (not shown). The lay up matrix component stacks 10a and 20a are placed on carrier sheets known as “caul plates” to facilitate handling during lay-up, and fusion or bonding under heat and pressure. A second caul plate is also placed on the top of the lay up matrix component stacks 10a and 20a as well.

Optionally, texture and release papers or films may be used to bracket the sandwich, thereby aiding in the formation and texturing of the final lay up matrices 10b and 20b but the use of such films or papers is not necessary to embodiments of the invention. A variety of suitable texture papers are available from S. D. Warren, Westbrook, Maine and release films (polyester, polyvinyl fluoride and perfluoroalkoxy tetraflouroethylene) are available from DuPont™, Buffalo, N.Y. The papers and films have specific textures and gloss levels that are transferred into the thermoplastic sheet laminate when the laminate is at the optimal heat and pressure and prevent the plastic sheet from sticking to the caul plate.

Padding may also be used to make uniform the application of pressure across lay up matrix component stacks 10a and 20a thereby accommodating any deviations from a truly planar surface in the lay up matrices 10b and 20b as bonded or fused. Where the first generally planar sheet 12 and the second generally planar sheet 15 includes thermoplastics, single or multiple layers of # 6 Duck canvas sheets, or other suitable padding material including silicone and Nomex felt, are advantageously placed below the bottom caul plate and above the top caul plate as padding to distribute pressure and heat during pressing. The thickness of the padding is adjusted based on the amount of heat and pressure equalization required. The lay up matrix component stack along with the top and bottom caul plates and canvas pads is called a “book.”

At the blocks 54 and 57, where either the first generally planar sheet 12 and the second generally planar sheet 15 should include a textured effect as desired, a textured or etched sheet of glass is used as the top or bottom layer of the laminate. Also, while a canvas padding is generally used to fuse the thermoplastic lay up matrix component stacks 10a or 20a into the lay up matrices 10b or 20b, advantageously, 0.125″, 45 durometer silicone sheets are placed between the the first generally planar sheet 12 and the second generally planar sheet 15 and the top and bottom caul plates. Such silicone sheets will also work with thermoplastic fusion but canvas padding has proven more economical. The silicone sheets provide greater pressure equalization and help to prevent the glass in the generally planar sheets 12, 15 from cracking.

During the fusion or bonding process, the surface of the thermoplastic laminate can be embossed or textured using resign coated release papers or films. The thermoplastic laminates are assembled on 0.060″ aluminum carrier sheets “caul plates” to facilitate handling during lay-up and pressing. A 0.060″ aluminum caul plate is also placed on the top of the laminate during pressing to maintain a smooth and clean surface. Single or multiple layers of # 6 Duck canvas sheets, or other suitable padding material including silicone and Nomex felt, are placed below the bottom caul plate and above the top caul plate as padding to distribute pressure and heat during pressing. The thickness of the padding is adjusted based on the amount of heat and pressure equalization required. The finish lay-up of the laminate materials, top and bottom caul plates and canvas pads is called a “book”. The book is placed on a 0.125″ aluminum sheet (“loader pan”) to facilitate loading and unloading of the book into the press.

In various embodiments of the invention, at a block 60 the lay up matrix component stacks 10a and 20a are inserted into any of the heat and pressure vessels set forth in the discussion above. Such vessels include the multiple opening lamination press (MOP), autoclave, vacuum bag laminator, vacuforming machine, or other suitable machine that can apply the required heat and pressure to fuse the materials together. In one embodiment of the invention, the lay up matrix component stacks 10a and 20a and assembled at the blocks 51 through 57 by interleafing materials in the course of co-extrusion on opposing sides of a suitably fed sheet of decorative material 18. In this process, the decorative material 18, typically any of fabric, paper or plastic film is roll laminated between the thermoplastic first generally planar sheet 12 and the thermoplastic second generally planar sheet 15. An embossing roller can optionally be used to control texture and gloss level of the sheet during extrusion.

In one embodiment of the invention, an MOP is used to bond or to fuse the first generally planar sheet 12 and the thermoplastic second generally planar sheet 15 to the decorative sheet 18 and to each other. When bonding the thermoplastic first generally planar sheet 12 and the thermoplastic second generally planar sheet 15 in a MOP, temperatures will range from 185 degrees Fahrenheit to 600 degrees Fahrenheit.

The lay up matrices 10b and 20b should be held for a first duration, at a first temperature, and first pressure and fused together at a block 60. Decorative materials 18 can degrade under heat and pressure resulting in discoloration, color bleed and separation. Also, certain adhesives can react with materials within the laminate causing out-gassing, which creates bubbles within the laminate and poor adhesion. During the duration, outgases are removed from the lay up matrices 10b and 20b, either by venting or bumping the press, or by application of a vacuum to draw out the gasses at pressures below the ambient at a block 63.

The lay up matrices 10b and 20b, at a block 66, is held for a second duration, at a second temperature, and a second pressure in order to remove such stresses that may have been introduced in the course of the thermal expansion of the lay up matrices 10b and 20b at the block 60. The second temperature and pressure need not be distinct from the first temperature and first pressure. Removal of thermally induced stresses assures optimal clarity and conformance of the lay up matrix either to the press plates or to such molding forms as may be used at block 60.

To further avoid thermally induced stresses, at a block 69, the lay up matrix is cooled at a rate selected to assure that there will not be abrupt contraction of either of the first generally planar sheet 12 and the thermoplastic second generally planar sheet 15 relative to each other or relative to the decorative material 18. In most instances, allowing the controlled cooling of the lay up matrices 10b and 20b gradually under pressure, may be continued until the lay up matrices 10b and 20b reaches substantially room temperature, in most instances approximately 100 degrees Fahrenheit.

In one embodiment, a thermocouple is used to monitor the declining temperature while either applying or removing such heat as is necessary to suitably retard the cooling according to a selected rate using a temperature monitor; the temperature monitor should be placed advantageously in order monitor temperatures to the edge of the laminate in order to control temperature. The optimal temperature and time curve will vary depending on material combinations and laminate thickness, for example, a 0.120″ acrylic laminate with most paper and fabric decorative materials can generally be bonded without adhesive at 280 degrees for 5 minutes at 160 psi.

In an embodiment, rather than to allow the materials to cool within the original press, the book is moved to a second press configured to suitable lower the temperature of the book at a selected rate to insure the continued clarity of the matrix while relieving stress introduced in the fusing process. Maintaining the clarity of the matrix insures the continued translucent nature and aesthetic value of the resulting matrix.

Once cooled at the block 69, the lay up matrices 10b and 20b can be shaped and fabricated with standard techniques known by those with ordinary skill in the art. Uses for the lay up matrices 10b and 20b include, for example, point of purchase displays, retail fixtures and furnishings, signage, shelving, walls and partitions, glazing, safety glazing (used for security, for ballistic protection, or for storm protection), shower doors and enclosures, sky lights, light lenses, window blinds, and shades, furniture, cabinets, speaker boxes, splash guards, dividers, consumer products, counter tops, retail and home décor items such as clock faces, vases, picture frames, and coasters. The lay up matrices 10b and 20b have wide application as replacement materials for glass and plastic both for decorative purposes and for formulating panels with either of defined safety or structural requirements.

In another embodiment of the present invention, the completed lay up matrices 10b and 20b are highly impact resistant or bullet resistant. A bullet resistant panel can be constructed, for example, by an outer transparent sheet of acrylic resin, an inner transparent sheet of polycarbonate resin, and a transparent polyurethane adhesive between the two sheets bonding them together to form an integral panel. Typically, the acrylic resin sheet has a high degree of hardness, but is somewhat brittle, while the polycarbonate sheet is not as hard and is less brittle. The combination of the two sheets, with a very hard outer surface and a force absorbing inner layer, provides a high degree of impact resistance against penetration by rocks, bullets, or other projectiles.

Alternative impact or bullet resistant panels can be formed by using processes such as those described in U.S. Pat. Nos. 5,747,159 to Labock; 5,506,051 to Levy-Borochov et al.; 4,647,493 to LeGrand et al.; 6,630,235 to Oshima et al.; 6,726,979 to Friedman et al.; and 5,061,333 to Ishikawa et al., which are hereby incorporated by reference. In most cases, panels are joined together, in which an outer panel has a degree of hardness that differs from an inward-facing layer. These differences between the outward-facing layer and inward-facing layer can be achieved by using different materials, different thicknesses, or other means.

The impact-resistant or bullet resistant form of the invention may take the form as illustrated in FIG. 1a, in which the layers 12 and 15 comprise panels of differing harness, as described above. In the preferred form, an additional layer of decorative material 18 is included, to provide a bullet resistant or highly impact resistant panel that is also decorative. Preferably, the decorative layer is included between layers 12 and 15. In alternate forms, the decorative layer may be added to the outside of one or the other of layers 12 or 15. In such cases, an additional optional clear layer of acrylic or other thermoplastic material may be included to protect the decorative layer.

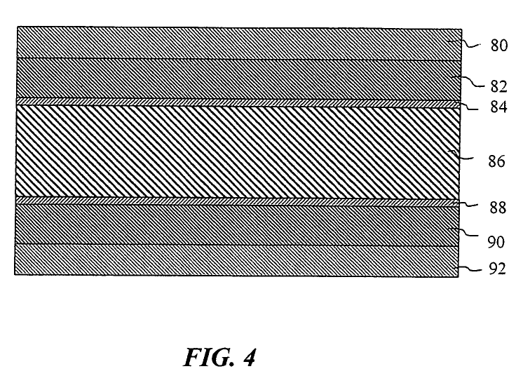

The methods described hereinabove may be used to form the bullet resistant laminate of FIG. 4. The laminate includes a first outer layer 80, a first decorative layer 82, a first adhesive layer 84, a structural layer 86, a second adhesive layer 88, a second decorative layer 90, and a second outer layer 92.

The first and second outer layers 80, 92 may be abrasion resistant or have an abrasion resistant coating. In the illustrated embodiment, ⅛ inch polycarbonate, acrylic, or glass is used. The adhesive layers 84, 88 may adhere the first and second outer layers 80, 92 and the decorative layers 82, 90 to the structural layer 86. In the illustrated embodiment the adhesive layer is a polyurethane adhesive, which may have a thickness of 25 to 50 thousandths of an inch. The structural layer 86 may be embodied as glass, or optical quality aliphatic ether and clear polycarbonate or acrylic. In the illustrated embodiment, ½ inch polycarbonate is used.

The layers of the bullet-resistant laminate may be assembled to form a lay-up sandwich which is processed according to the methods described above in order to fuse the layers. For bullet-resistant laminates formed of polycarbonate, acrylic, and polyurethane adhesives, the press may be heated to a temperature of from 185 to 257° F. and apply a pressure of from 50 psi to 200 psi. Various embodiments for the layers forming the bullet-resistant laminate may be used. For example, a single decorative layer 82, 90 may be included. Furthermore, multiple structural layers 42 secured to the laminate by additional adhesive layers 84, 88 may be included. Additional decorative layers 82, 90 may likewise be included. The bullet resistant properties of the laminate of FIG. 4 and other exemplary laminates is summarized below in Table 1.

TABLE 1
Bullet resistant properties of laminate

| Description | Gauge | Expected Performance |
|---|---|---|
| 3/16 Polycarbonate | .390 | HPW Level II Step 10 |
| Polyurethane or other adhesive | | HPW TP0500.02 Level A |
| Décor | | Ballistics |
| 3/16 Polycarbonate Abrasion Resistant | | (.38 Special) |
| | | ASTM F1233 Class III Step 12 |
| ⅛ Polycarbonate Abrasion Resistant | .530 | HPW Level II Step 12 |
| Polyurethane or other adhesive | | HPW TP0500.02 Level A |
| Décor | | Ballistics |
| ¼ Polycarbonate | | (.38 Special) |
| Polyurethane or other adhesive | | ASTM F1233 Class III Step 15 |
| Décor | | |
| ⅛ Polycarbonate Abrasion Resistant | | |
| ⅛ Polycarbonate Abrasion Resistant | .780 | HPW Level IV Step 31 |
| Polyurethane or other adhesive | | HPW TP0500.02 Level B |
| Décor | | Ballistics |
| ½ Polycarbonate | | (9 mm) |
| Polyurethane or other adhesive | | ASTM F1233 Class IV Step 26 |
| Décor | | |
| ⅛ Polycarbonate Abrasion Resistant | | |
| ⅛ Polycarbonate Abrasion Resistant | .775 | HPW TP0500.02 Level B |
| Polyurethane or other adhesive | | Ballistics |
| Décor | | (9 mm) |
| ½ Acrylic | | UL Level I |
| Polyurethane or other adhesive | | |
| Décor | | |
| ⅛ Polycarbonate Abrasion Resistant | | |
| ⅛ Polycarbonate Abrasion Resistant | 1.05 | HPW Level V Step 42 |
| Polyurathane or other adhesive | | HPW TP0500.02 Level B |
| Décor | | Ballistics |
| ⅜ Polycarbonate | | (9 mm) |
| Polyurathane or other adhesive | | UL Level 2 |
| Décor | | |
| ⅜ Polycarbonate | | |
| Polyurathane or other adhesive | | |
| Décor | | |
| ⅛ Polycarbonate Abrasion Resistant | | |
| ⅛ Polycarbonate Abrasion Resistant | 1.30 | HPW Level V |
| Polyurathane or other adhesive | | HPW TP0500.02 Level C |
| Décor | | Ballistics |
| ½ Polycarbonate | | (.44 magnum) |
| Polyurathane or other adhesive | | ASTM F1233 Class IV Step 38 UL Level 3 |
| Décor | | |
| ½ Polycarbonate | | |
| Polyurathane or other adhesive | | |
| Décor | | |
| ⅛ Polycarbonate Abrasion Resistant | | |

The products of the methods described above may be curved or flat. Curvature may be accomplished by using curved sheets 12 and 15 as starting material. Alternatively, curved plates may be used during the pressing operations to simultaneously laminate and form the lay-up sandwich into a curved finished product. In other embodiments, the sheets 12 and 15 and decorative material 18 may first be laminated followed by forming of the laminate into a curved shape.

Curved laminates may be formed into basins for sink bowls, soap trays and the like. In some embodiments, curved features such as sink bowls and soap trays are formed within a portion of a planar structure to form integrated features. For example, a sink may be formed within a counter top.

The planar products of the methods described above may be used in other applications. For example, a laminate may be used as flooring tiles or panels. The laminate may also be used a ceiling and wall panels or as a door or insert within a door. The transparent nature of the laminate may render it suitable for use as a decorative window or the like. An appliance case or face plate may be formed using the laminate. The case or face plate may have labeling, switches, knobs, and the like, relating to the operation of the appliance embedded therein by the novel process described above.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A highly impact resistant, non-porous unitary solid surface structure comprising:
a first non-porous unitary material;
a decorative material; and
a second non-porous unitary material, the second non-porous unitary material fused in opposed relation to the first non-porous unitary material relative to the decorative material,
wherein the resulting structure is bullet resistant.

2. The structure of claim 1, wherein the decorative material is made of a dry material, wherein the dry material includes at least one of textile fabric, paper, plastic film, a plastic sheet, metallic wire, a metallic part, electroluminescent, LED, a fiber optic material, a marble, a seed, a magnet, a shell, a bead, a crystal, glass, a photoluminescent material, a mineral nugget, rod, mesh, bar, wood veneer, a dried natural material, tree bark, a plant leaf, a petal, a twig and an electrical motor.

3. The structure of claim 1, wherein the decorative material includes at least one fluid vessel.

4. The structure of claim 1, wherein at least one of the outer surfaces of the materials is embossed or textured.

5. The of claim 1, wherein the first non-porous unitary material is configured to form at least one of a bowl, a sink, a countertop, or a panel.

6. The of claim 1, wherein at least one of the first or second non-porous unitary materials is configured to include an antimicrobial polymer.

7. A method for manufacturing a non-porous unitary solid surface structure comprising the steps of:
placing a decorative material on a first non-porous unitary layer of polymeric material wherein the decorative material is made of a dry material;
placing a second non-porous unitary layer of polymeric material on top of the decorative material, whereby a sandwich is formed;
applying a heat and pressure to the sandwich, whereby said first and second polymeric material layers melt together in the lay-up sandwich to provide a unitary product; and
cooling the product while under pressure;
wherein the first and second polymeric materials are chosen to render the product bullet resistant.

8. The method of claim 7, wherein:
the applied heat is between 185 and 600 degrees Fahrenheit,
the applied pressure is between 50 and 250 PSI, and
the heat and pressure is applied for between 3 seconds and 45 minutes.

9. The method of claim 7, wherein the polymeric material of the first non-porous layer includes at least one of acrylic, cross-linked acrylic, polymethyl methacrylate, polycarbonate, polyvinyl chloride, polyethylene, polypropylene, polyester, nylon, polyurethane, polystyrene, fluoropolymers, acrylonitrile-butadiene-styrene, polylactic acid, and cellulosics.

10. The method of claim 9, wherein the polymeric material of the second second non-porous unitary layer includes at least one of acrylic, cross-linked acrylic, polymethyl methacrylate, polycarbonate, polyvinyl chloride, polyethylene, polypropylene, polyester, nylon, polyurethane, polystyrene, fluoropolymers, acrylonitrile-butadiene-styrene, polylactic acid, and cellulosics.

11. The method of claim 10, wheein the decorative material includes at least one of textile fabric, paper, plastic film, plastic layer, metallic wire, a metallic part, electroluminescent, LED, a fiber optic material, a marble, a seed, a magnet, a shell, bead, a crystal, glass, a photoluminescent material, a mineral nugget, rod, mesh, bar, wood veneer, a dried natural material, tree bark, a plant leaf, a petal, and a twig.

12. The method of claim 7, further comprising:
bonding a film to a surface of the first non-porous layer in opposed relation to the decorative material.

13. The method of claim 12, wherein the film includes at least one of polymethyl methacrylate PHMA, Polycarbonate, polyvinyl chloride, PETG, copolyester, polyethylene, polypropylene, polyester, PVDF such as Kynar™, PVF such as Tedlar™, and polyurethane.

14. The method of claim 7, wherein the first non-porous unitary layer is a sheet.

15. A highly impact resistant, unitary solid surface structure comprising:
a first layer of translucent material having a first degree of hardness and a first degree of brittleness;
a second layer of translucent material having a second degree of hardness and a second degree of brittleness, the first degree of hardness being relatively greater than the second degree of hardness and the first degree of brittleness being relatively greater than the second degree of brittleness, the first layer being bonded to the second layer to form a panel; and
a decorative material layer visibly secured to the panel;
whereby the resulting panel is highly impact resistant.

16. The structure of claim 15, wherein the decorative material layer is sandwiched between the first layer and the second layer.

17. The structure of claim 15, wherein the decorative material layer is secured to an outer face of at least one of the first layer and the second layer.

18. The structure of claim 15, wherein the resulting panel is bullet resistant.

19. The structure of claim 18, wherein the resulting panel is bullet resistant to the extent of the ASTM F1233 Class III Step 12 rating.

20. The structure of claim 15, wherein the first layer of translucent material is formed as a sheet.

21. The structure of claim 15, wherein the first layer and second layer are curved.

22. The structure of claim 15, further comprising an electrical device comprising a housing substantially enveloping the electrical device, the first layer and second layer forming a portion of the housing.

23. The structure of claim 15, wherein the first and second layer are over lay at least one of a wall, floor, and ceiling of a building.

24. The structure of claim 24, further comprising a door hingedly secured to a wall of a building, the first and second sheet being embedded within the door.
